(19) United States
(12) Patent Application Publication
(10) Pub. No.: US 2018/0063784 A1
(43) Pub. Date: Mar. 1, 2018

(54) DEVICES AND METHODS FOR AN EFFICIENT WAKEUP PROTOCOL

(71) Applicant: QUALCOMM Incorporated, San Diego, CA (US)

(72) Inventors: Santosh Abraham, San Diego, CA (US); Linhai He, San Diego, CA (US); Stephen Jay Shellhammer, Ramona, CA (US); Rashid Ahmed Akbar Attar, San Diego, CA (US)

(21) Appl. No.: 15/249,219

(22) Filed: Aug. 26, 2016

(51) Int. Cl. H04W 52/02

(52) U.S. Cl. CPC H04W 52/0216; H04W 52/0235; H04W 52/0229

(57) ABSTRACT

Aspects of the subject matter described in this disclosure can be implemented in an efficient wakeup protocol for discovery between two devices. A first device configured to transmit discovery signals can wake up at a predetermined drift time, and a second device configured to receive the discovery signals can wake up at a predetermined wakeup time shortly after the predetermined drift time. The second device can remain awake for a very short duration, where the duration can be based on the packet length of the discovery signal or the interval between each transmitted discovery signal. Upon receiving a discovery signal, the second device can pair with the first device so that further communications can occur between the two devices.

### TECHNICAL FIELD

This disclosure relates generally to a wakeup protocol, and more particularly, to an efficient wakeup protocol for pairing two electronic devices together for data transfer.

### DESCRIPTION OF RELATED TECHNOLOGY

Information sharing across electronic devices is becoming more common with device-to-device wireless communication. Electronic devices can be paired together so that the electronic devices are associated with one another, and the electronic devices can share information by wirelessly transferring data.

However, power consumption is a big concern with some electronic devices, especially with battery-powered devices. An example of a battery-powered device can include an implantable medical device that is configured to wirelessly communicate data with a device outside of a patient's body. Currently, implantable medical devices are being used in many different parts of the body for various applications, such as orthopedics, pacemakers, cardiovascular stents, defibrillators, neural prosthetics, neuro stimulation, or drug delivery. The performance of such implantable medical devices can be critical to improving the quality of life of millions of patients. Several challenges can limit the performance and effectiveness of implantable medical devices, including challenges related to power consumption of the implantable medical devices and reliably establishing communication with the implantable medical devices.

Generally, a device concerned with power consumption may enter into a sleep mode or power-saving mode so that various components of the device are inactive. In some instances, the device can be in an off state or inactive state but operate in a “listening” mode, “discovery” mode, or “sniff” mode, where a wireless communications component (e.g., receiver or transceiver) of the device can be turned on. In fact, the device can reduce power consumption even more by keeping the wireless communications component turned on for a limited period of time, during which the device listens to see if there are any signals wanting to establish communication and pair with the device.

Because some devices have severe power constraints, it is desirable to extend the battery lifetime of these devices by keeping them asleep whenever possible, by minimizing the number of data transmissions to other devices, by reliably discovering other devices to shorten duty cycles, and by minimizing the power consumed in discovering other devices. For example, rather than constantly sending out communications, a device in discovery mode can save power by waking up to discover another device and then establish secured communication between the two devices. In an effort to reduce power consumption, an efficient wakeup protocol is desirable so that there is minimal data transmission and minimal searching occurring at the device in discovery mode. While applicable to a whole host of devices and systems, an efficient wakeup protocol can be critical in improving the performance and lifetime of implantable medical devices.

### SUMMARY

The systems, methods and devices of this disclosure each have several aspects, no single one of which is solely responsible for the desirable attributes disclosed herein.

One aspect of the subject matter described in this disclosure can be implemented in an electronic device. The electronic device includes a wireless communications component configured to receive a discovery beacon and a control system coupled to the wireless communications component. The control system is configured to cause the wireless communications component to be in an active state at a predetermined wakeup time (T2) for a predetermined duration (T_exp). The control system is further configured to receive, at the wireless communications component, at least one of a plurality of discovery beacons transmitted by a remote device, where the predetermined duration (T_exp) is: (a) less than a first reference value times a packet length (T_packet) of the discovery beacon, or (b) less than a second reference value times a regular interval (T_beacon) between each of the plurality of discovery beacons. The control system is further configured to, in response to the electronic device receiving at least one of the discovery beacons, establish communication for data transfer with the remote device

In some implementations, the wireless communications component is caused to be in an active state at a predetermined wakeup time (T2) after the remote device is activated at a predetermined drift time (T1). In some implementations, the electronic device further includes a clock with an associated clock drift (D), where the wireless communications component is caused to be in an active state at a predetermined wakeup time (T2) after the predetermined drift time (T1) by a duration based at least in part on the clock drift (D). In some implementations, the control system is further configured to set the wireless communications component to a sleep state after data transfer is completed with the remote device, and cause the wireless communications component to be in the active state at regular periods (T_schedule) after setting the wireless communications component to the sleep state. Each regular period (T_schedule) can be greater than 1 hour. The predetermined duration (T_exp) is 5 milliseconds or less. In some implementations, the control system configured to cause the wireless communications component to be in the active state at the predetermined wakeup time (T2) is configured to cause the wireless communications component to be in the active state on a preassigned channel. In some implementations, the control system is further configured to select a channel on a frequency band for establishing communication for data transfer with the remote device. The control system can be further configured to perform a search across a plurality of channels in the frequency band according to a predetermined sequence, and receive, at the wireless communications component after performing the search, at least one of the plurality of discovery beacons at one of the searched plurality of channels.

Another aspect of the subject matter described in this disclosure can be implemented in a remote device. The remote device includes a wireless communications component configured to transmit a plurality of discovery beacons, and a control system coupled to the wireless communications component. The control system is configured to cause the wireless communications component to be in an active state at a predetermined drift time (T1). The control system is further configured to transmit a plurality of discovery beacons to be received by an electronic device, where the wireless communications component is caused to be in an active state at a predetermined drift time (T1) before the electronic device is activated at a predetermined wakeup time (T2), each discovery beacon being transmitted at a regular interval (T_beacon), and each discovery beacon having a packet length (T_packet), the electronic device being activated for a predetermined duration (T_exp) that is: (a) less than a first reference value times the packet length (T_packet) of the discovery beacon, or (b) less than a second reference value times the regular interval (T_beacon). The control system is further configured to establish communication for data transfer with the electronic device.

In some implementations, the wireless communications component is caused to be in an active state at the predetermined drift time (T1) before the predetermined wakeup time (T2) by a duration based at least in part on a clock drift (D) associated with the electronic device. In some implementations, the control system is further configured to set the wireless communications component to a sleep state after data transfer is completed with the electronic device, and cause the wireless communications component to be in the active state for transmitting discovery beacons at regular periods (T_schedule) after setting the wireless communications component to the sleep state. Each regular period (T_schedule) is greater than 1 hour, and the predetermined duration (T_exp) is 5 milliseconds or less.

Another aspect of the subject matter described in this disclosure can be implemented in a non-transitory computer readable medium having software stored thereon. The software includes instructions for causing an electronic device to cause a wireless communications component of the electronic device to be in an active state at a predetermined wakeup time (T2) for a predetermined duration (T_exp). The software further includes instructions to receive at least one of a plurality of discovery beacons transmitted by a remote device, where the predetermined duration (T_exp) is: (a) less than a first reference value times a packet length (T_packet) of the discovery beacon, or (b) less than a second reference value times a regular interval (T_beacon) between each of the plurality of discovery beacons. The software further includes instructions to, in response to the electronic device receiving at least one of the discovery beacons, establish communication for data transfer with the remote device. In some implementations, the software further includes instructions for causing the electronic device to set the wireless communications component to a sleep state after data transfer is completed with the remote device, and cause the wireless communications component to be in the active state at regular periods (T_schedule) after setting the wireless communications component to the sleep state. In some implementations, the electronic device includes a clock with an associated clock drift (D), where the wireless communications component is caused to be in an active state at a predetermined wakeup time (T2) after the predetermined drift time (T1) by a duration based at least in part on the clock drift (D). In some implementations, each regular period (T_schedule) is greater than 1 hour, and the predetermined duration (T_exp) is 5 milliseconds or less.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a schematic diagram illustrating an example system including a remote device and an electronic device implanted inside a patient's body according to some implementations.

FIG. 2 shows a block diagram representation of components of an example electronic device according to some implementations.

FIG. 3 shows a block diagram representation of components of an example remote device according to some implementations.

FIG. 4 shows a flow diagram illustrating an example process of establishing communication for data transfer between a first device and a second device according to some implementations.

FIG. 5A shows a timing diagram illustrating an example wakeup protocol of a first device and a second device according to some implementations.

FIG. 5B shows a timing diagram illustrating an example wakeup protocol of a first device and a second device according to some other implementations.

FIG. 6 shows a flow diagram illustrating an example process of searching across a plurality of channels in a frequency band according to some implementations.

FIG. 7 shows a block diagram representation of discovery channels in a frequency band according to some implementations.

FIG. 8 shows a flow diagram illustrating an example process for waking up an electronic device to establish communication for data transfer with a remote device according to some implementations.

FIG. 9 shows a flow diagram illustrating an example process for waking up a remote device to establish communication for data transfer with an electronic device according to some implementations.

Like reference numbers and designations in the various drawings indicate like elements.

### DETAILED DESCRIPTION

The following description is directed to certain implementations for the purposes of describing various aspects of this disclosure. However, a person having ordinary skill in the art will readily recognize that the teachings herein can be applied in a multitude of different ways. Various embodiments will be described in detail with reference to the accompanying drawings. References made to particular examples and implementations are for illustrative purposes, and are not intended to limit the scope of the claims.

The described implementations may be implemented in any device, apparatus, or system that is configured to communicate with another device, apparatus, or system. In addition, it is contemplated that the described implementations may be included in or associated with a variety of electronic devices such as, but not limited to: mobile telephones, multimedia Internet enabled cellular telephones, mobile television receivers, wireless devices, smartphones, smart cards, wearable devices such as bracelets, armbands, wristbands, rings, headbands, patches, belts, etc., Bluetooth® devices, personal data assistants (PDAs), wireless electronic mail receivers, hand-held or portable computers, netbooks, notebooks, smartbooks, tablets, printers, copiers, scanners, facsimile devices, global navigation satellite system (GNSS) receivers/navigators, cameras, digital media players (such as MP3 players), camcorders, game consoles, wrist watches, clocks, calculators, television monitors, flat panel displays, implantable medical devices, interrogator medical devices, electronic reading devices (e.g., e-readers), mobile health devices, medical devices, computer monitors, auto displays, cockpit controls and/or displays, steering wheels, camera view displays, electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, etc. By way of example, the described implementations may be implemented in a battery-powered electronic device. For example, the described implementations may be implemented in an implantable medical device, such as a neuro stimulator. Some of the described implementations may be implemented in an interrogator medical device for communicating with an implantable medical device. Some of the described implementations may be implemented in a system including the interrogator medical device and the implantable medical device. Nonetheless, the teachings are not intended to be limited to the implementations depicted solely in the Figures, but instead have wide applicability as will be readily apparent to one having ordinary skill in the art.

This disclosure relates generally to devices, systems, and methods regarding an efficient wakeup protocol for an electronic device discovering another electronic device. A first device can transmit discovery signals at a designated time. A second device can be configured to wake up at a scheduled time shortly after the designated time to receive one or more of the discovery signals, and remains awake for a very short duration. The scheduled time can be based on an internal clock value of the second device and the duration can be based on the discovery signals, such as the frequency of transmission between discovery signals or the packet length of a discovery signal. Upon detecting a discovery signal, the first and second devices can be paired so that secured data transfer can occur between the paired devices. If data transfer is completed, if the second device fails to detect a discovery signal, or if the second device fails to initiate a session for transferring data, the second device returns to a sleep state until another scheduled wakeup time.

Particular implementations of the subject matter described in this disclosure can be implemented to realize one or more of the following potential advantages. The wakeup protocol improves the performance and lifetime of an electronic device by reducing its power consumption. The electronic device can save power by reducing the duration in which the electronic device is awake listening for discovery signals and by reducing the frequency in which the electronic device is awake listening for discovery signals. The electronic device saves power by not transmitting data while listening for discovery signals and is awake for as short a time as is necessary to discover the device sending the discovery signals. In addition, the time that the electronic device is awake can be scheduled so that it is coordinated with the device sending the discovery signals. As a result, the electronic device can reliably receive the discovery signal while the electronic device is awake, which can further shorten the duration that the electronic device is awake listening for discovery signals. Furthermore, if discovery can occur on different channels, the electronic device can be configured to efficiently search across the different channels to minimize time and resources spent searching. The electronic device can reduce power consumption by shortening its duty cycles listening for discovery signals, minimizing the number and frequency of data transmissions, ensuring discovery within the duration that it is awake, and minimizing searching for the device sending the discovery signals.

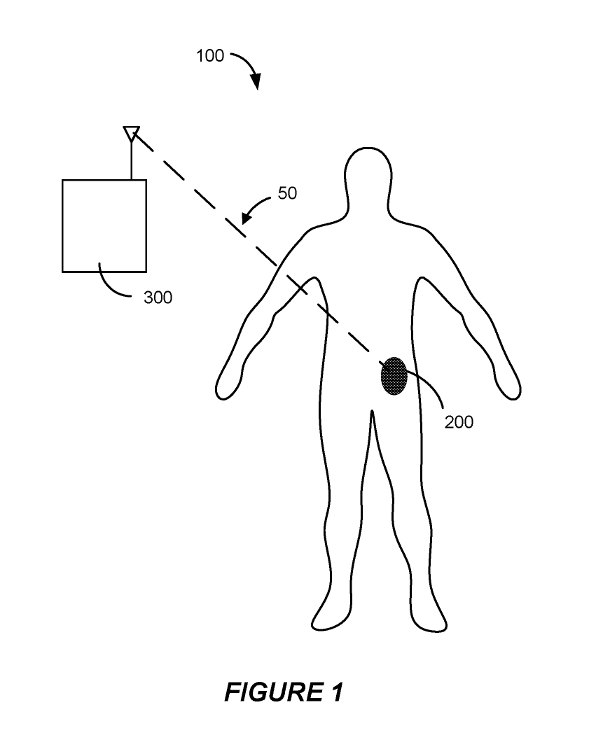

FIG. 1 shows a schematic diagram illustrating an example system including a remote device and an electronic device implanted inside a patient's body according to some implementations. The system 100 includes an electronic device 200 and a remote device 300. The remote device 300 can be configured to transmit one or more discovery beacons 50 and the electronic device 200 can be configured to receive one of the discovery beacons 50. In some implementations, the electronic device 200 is an implantable medical device. For example, the electronic device 200 may include but is not limited to cardiac pacemakers, implantable cardioverter-defibrillators (ICDs), implantable combination pacemaker-cardioverter defibrillator (PCDs), implantable brain stimulators, implantable gastric system stimulators, implantable nerve stimulators, implantable muscle stimulators, implantable lower colon stimulators, implantable drug dispensers or pumps, implantable cardiac signal loops or other types of recorders or monitors, implantable gene therapy delivery devices, implantable incontinence prevention or monitoring devices, implantable insulin pumps or monitoring devices, and so on. In some implementations, the electronic device 200 is battery-powered. The remote device 300 can be configured to facilitate wireless data transfer between the electronic device 200 and the remote device 300. In some implementations, the remote device 300 may include but is not limited to an external medical device, an interrogator medical device, a programming device, a remote telemetry station, a base station for the electronic device 200, a physician-activated device, a patient-activated device, a display device, or any other type of device capable of sending and receiving signals to and from the electronic device 200. In some implementations, the remote device 300 can send discovery beacons 50 while the electronic device 200 is in a listening mode, discovery mode, or sniff mode. Upon receipt of a discovery signal, the remote device 300 establishes communication for data transfer with the electronic device 200.

The scope of the present disclosure is not to be limited to systems including a remote device and an electronic device, an electronic device only, or a remote device only. Such systems, electronic devices, and remote devices are meant to be illustrative and are not intended to limit the scope of the present disclosure or the claims. Various modifications to the implementations described in the present disclosure may be readily apparent to those skilled in the art, and the generic principles defined herein may be applied to other implementations without departing from the spirit or scope of this disclosure. Thus, the present disclosure and the claims are not intended to be limited to the implementations shown herein, but are to be accorded the widest scope consistent with this disclosure, the principles and the novel features disclosed herein.

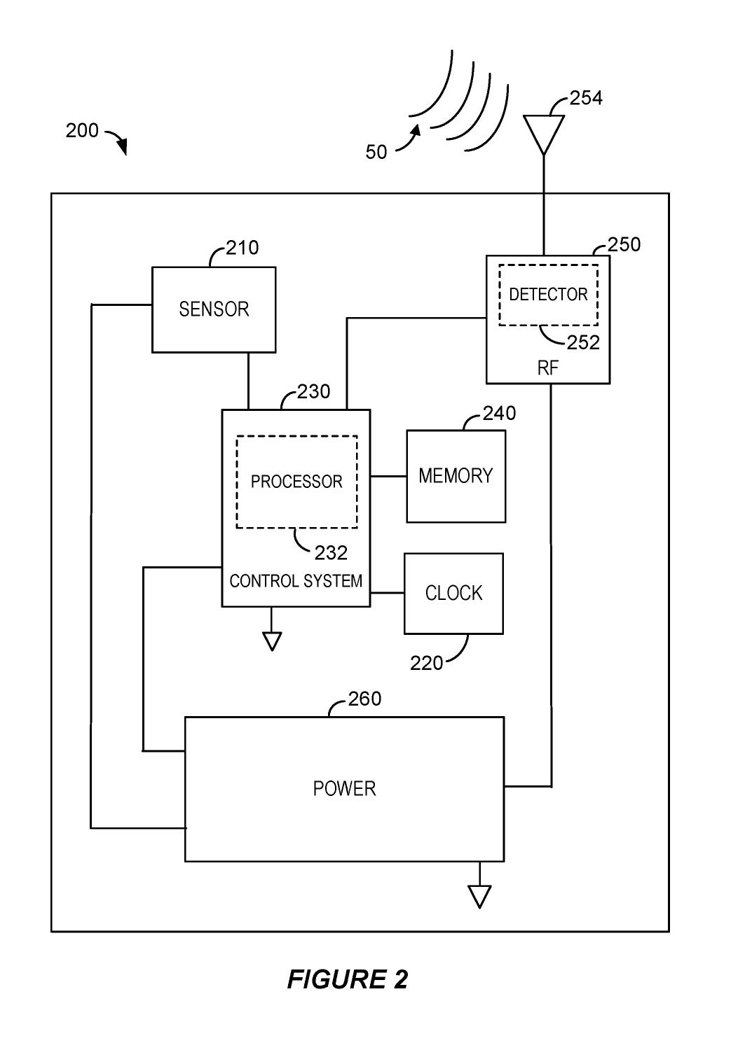

FIG. 2 shows a block diagram representation of components of an example electronic device according to some implementations. In some implementations, the electronic device 200 may be an implantable medical device. As with other implementations disclosed herein, the number of elements and types of elements shown in FIG. 2 are merely by way of example. Other implementations may have more, fewer, or different elements. In the implementation in FIG. 2, the electronic device 200 includes a sensor 210, a clock 220, a control system 230, a memory 240, a wireless communications component 250 coupled to an antenna 254, and a power supply 260. It is understood that the device 200 is not limited to implant devices, but can include any electronic device, such as a battery-powered electronic device.

In some implementations, the electronic device 200 includes one or more sensors 210. For example, where the electronic device 200 is a nerve stimulator, the one or more sensors 210 can be configured to measure the electrical stimulation activity of a nerve. In some implementations, data may be accessed from the one or more sensors 210 by the control system 230 and sent to a remote device, such as a device outside the patient's body.

The electronic device 200 can include a clock 220 internal to the electronic device 200. In some implementations, the clock 220 can include a crystal that oscillates at a particular frequency, such as at 32 KHz. While the clock 220 is generally reliable and sufficiently accurate over short periods of time, the clock 220 may be subject to inaccuracies over longer periods of time. Over longer periods of time, the clock 220 may be subject to a phenomenon called drift, in which a few seconds may be added or subtracted from the actual time over a span of days, weeks, months, or years. This inaccuracy can be determined with regard to a reference time (e.g., Greenwich Mean Time (GWT)). The effect of drift may be accentuated in a low-power device, including when the electronic device 200 is asleep or in a low-power state. If the clock 220 is inaccurate with respect to a reference time, this can lead to discrepancies in time-stamping recording of data, discrepancies in timing of therapy, and discrepancies in synchronization with devices outside the patient's body. The drift of the clock 220 can be measured in parts per million (PPM). Generally, PPM shows how much the clock 220 deviates from a nominal value. If the nominal value is one million seconds, then PPM is indicative of how much the clock 220 can deviate after one million seconds. For example, a clock 220 having +20 PPM can indicate that the clock deviates by +20 seconds after one million seconds.

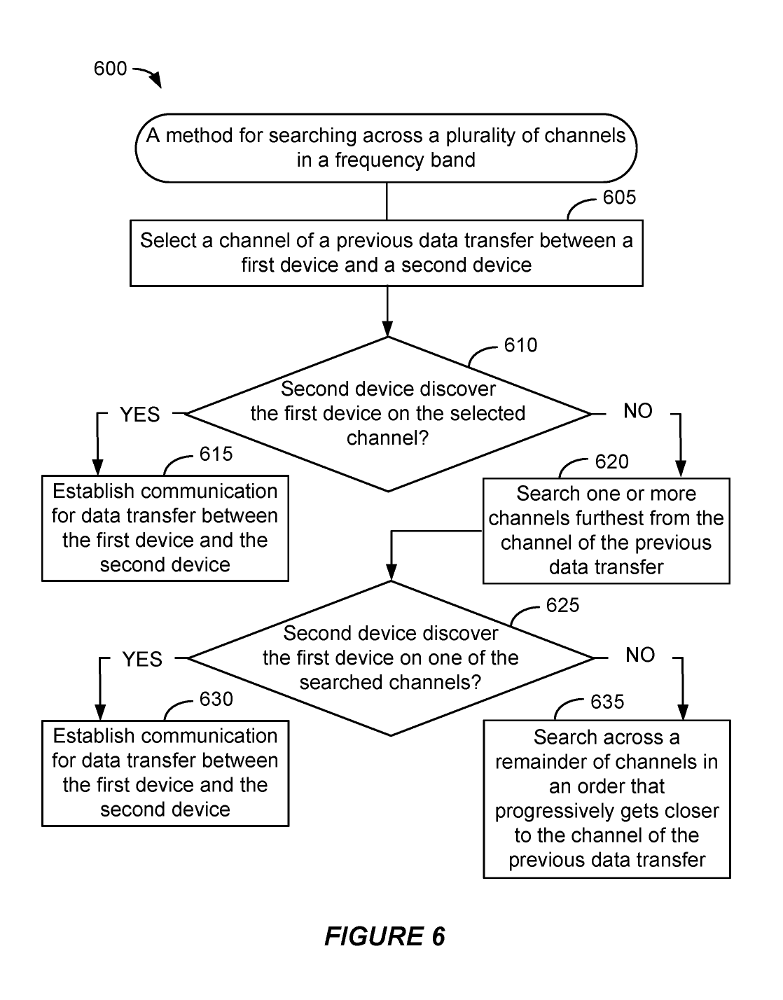

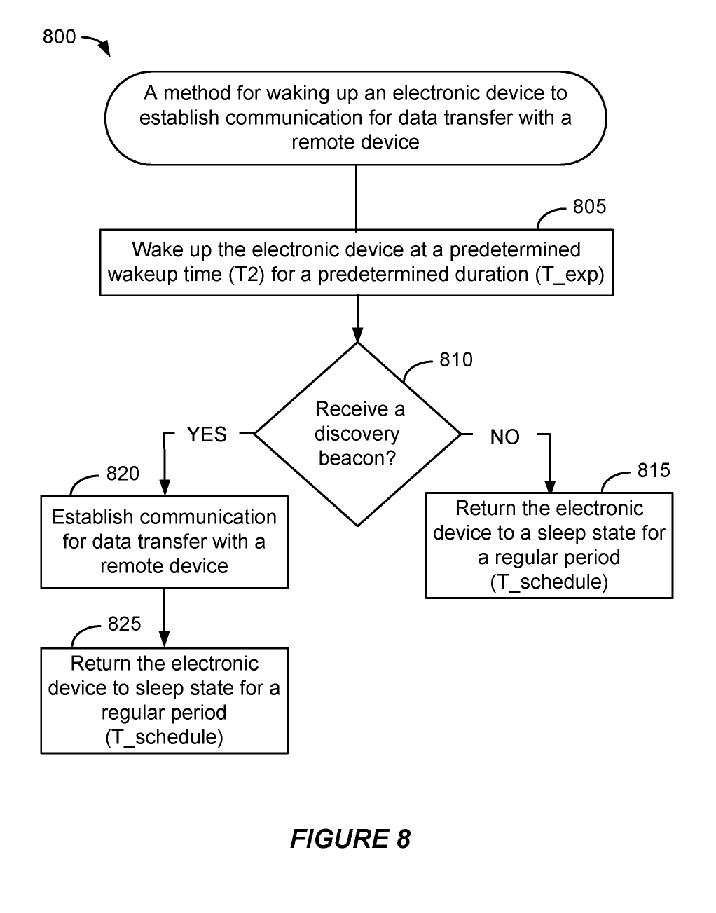

The electronic device 200 can include a control system 230. The control system 230 may include at least one of a general purpose single- or multi-chip processor, a digital signal processor (DSP), an application specific integrated circuit (ASIC), a field programmable gate array (FPGA) or other programmable logic device, discrete gate or transistor logic, or discrete hardware components. In some implementations, the control system 230 may include a processor 232. The control system 230 may be capable of performing some or all of the methods described herein. According to some examples, the control system 230 may be capable of performing a method described in a process 600, which is shown in FIG. 6. According to some examples, the control system 230 may be capable of performing a method described in a process 800, which is shown in FIG. 8. In some implementations, the control system 230 may be capable of controlling one or more components of the electronic device 200. For example, the control system 230 may be capable of controlling the one or more sensors 210. The control system 230 may be capable of controlling the wireless communications component 250.

In some implementations, the control system 230 may be capable of controlling the electronic device 200 according to instructions (e.g., software) stored on one or more non-transitory computer-readable media. Such non-transitory media may include the memory 240 of the electronic device 200. The memory 240 can store processor-executable instructions and/or outputs from the one or more sensors 210. In some implementations, the memory 240 may be a volatile memory, non-volatile memory (e.g., flash memory), or a combination thereof. In some implementations, the memory 240 may include internal memory included in the control system 230, memory external to the control system 230, or a combination thereof. The memory 240 may be coupled to the control system 230. In some implementations, the memory 240 may store information or instructions related to a wakeup protocol of the electronic device 200. For example, the memory 240 may store instructions for controlling the waking up, listening, and sleeping operations of the wireless communications component 250.

The electronic device 200 can include a wireless communications component 250 coupled to an antenna 254. The control system 230 may be coupled to the wireless communications component 250 to control the operations of the wireless communications component 250. In some implementations, the wireless communications component 250 may include one or more of a receiver, a transmitter, and a two-way transceiver. The wireless communications component 250 may operate in one or more frequency bands depending on the supported type of communications. Normally, the wireless communications component 250 of the electronic device 200 can be maintained in a power off or low power inactive “sleep” state to conserve power. The wireless communications component 250 may be periodically powered up or “woken” up, where the wireless communications component 250 is in an active state so that it can listen for discovery beacons 50. In an active state, the wireless communications component is capable of receiving discovery beacons 50 in a desired communication frequency band, such as the Medical Implant Communications Service (MICS) band, Medical Electronic Data Service (MEDS) band, or any other suitable frequency band. In some implementations, the wireless communications component 250 can be configured to receive signals at a frequency in the MICS band, where the MICS band is between about 400 MHz and about 405 MHz. In some implementations, the wireless communications component 250 can include a detector 252, such as a wakeup receiver or wakeup transceiver, configured to receive and detect the discovery beacon 50. If the electronic device 200 receives the discovery beacon 50 from a remote device while the electronic device 200 is in an active state or otherwise listening for discovery beacons 50, it can be determined that the remote device is trying to communicate with the electronic device 200, and one or more components in the electronic device 200 can be powered up to perform data transfer with the remote device.

In some implementations, one or more of the sensor 210, the clock 220, the control system 230, the memory 240, the wireless communications component 250, and any other electronic components of the electronic device 200 may be powered by the power supply 260. In some implementations, the power supply 260 may be a battery. In view of the power requirements of the electronic device 200, the battery of the power supply 260 may need to be regularly recharged or replaced. Consistently powering up or activating the wireless communications component 250 to listen for discovery beacons 50 can require electrical power that can drain the battery of the power supply 260. Reducing the time and frequency that the wireless communications component 250 listens for discovery beacons 50 can substantially reduce power consumption of the power supply 260.

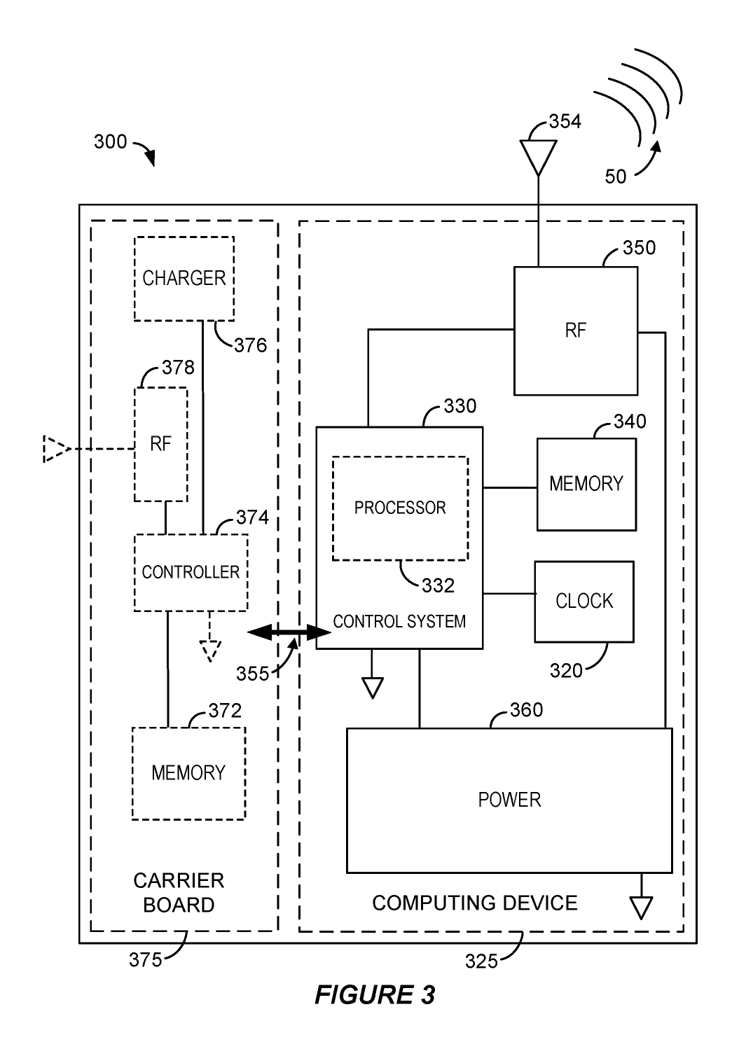

FIG. 3 shows a block diagram representation of components of an example remote device according to some implementations. As with other implementations disclosed herein, the number of elements and types of elements shown in FIG. 3 are merely by way of example. Other implementations may have more, fewer, or different elements. In the implementation in FIG. 3, the remote device 300 includes a clock 320, a control system 330, a memory 340, a wireless communications component 350, and a power supply 360. In some implementations, the remote device 300 includes a computing device 325 and a carrier board 375, where the computing device 325 includes the clock 320, the control system 330 including a processor 332, the memory 340, the wireless communications component 350, and the power supply 360. The carrier board can include a memory 372, a controller 374, a radio-frequency (RF) unit 378, and a charger 376. It is understood that the device 300 is not limited to remote devices, but can include any device capable of sending and receiving signals to and from the device 200. Examples of the device 300 can include an interrogator medical device, a programming device, a remote telemetry station, a base station, a physician-activated device, a patient-activated device, or a display device. In some implementations, the device 300 can serve as a base station for receiving data from the device 200 and transmitting discovery beacons 50 to the device 200.

In some implementations, a communication link 355 may be provided between the computing device 325 and the carrier board 375 so that a secure connection can be made between the computing device 325 and the carrier board 375. The computing device 325 may be a computer, such as an off-the-shelf computer, single-board computer, or programmable computer system. In some implementations, the communication protocol for the communication link can be Serial Peripheral Interface (SPI), though other suitable communication protocols known in the art, such as Universal Serial Bus (USB), may be applied. The communication link 355 may provide for a robust bidirectional communication interface.

The remote device 300 can include a clock 320, where the clock 320 can serve as a reference clock to accurately represent the time. The clock 320 can be any suitable clock, such as a mechanical clock, quartz clock, pendulum clock, and atomic clock. In some implementations, the clock 320 can be more closely aligned with the reference time and may be continuously powered by the power supply 360 so as to minimize or eliminate the effects of clock drift. In some implementations, when the remote device 300 establishes communication with an electronic device 200 of FIG. 2, a clock 220 of the electronic device 200 may be synchronized with the clock 320 of the remote device 300. However, in some other implementations, when the remote device 300 establishes communication with the electronic device 200, the clock 220 of the electronic device 200 is not synchronized with the clock 320 of the remote device 300.

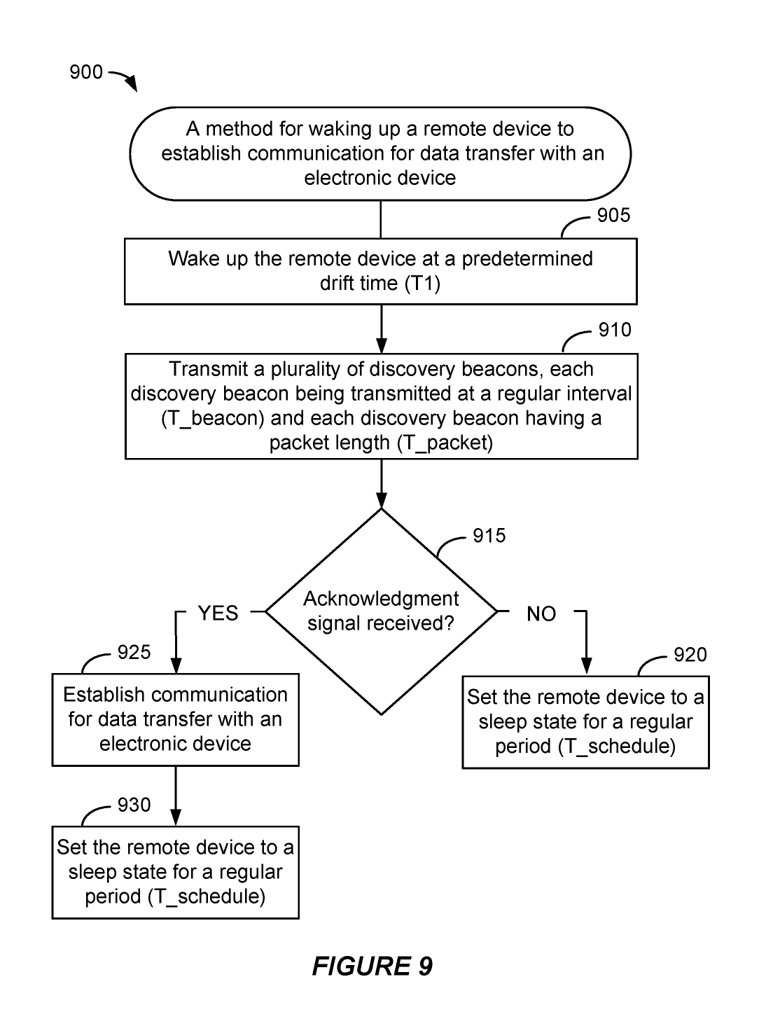

The remote device 300 can also include a control system 330. The control system 330 may include at least one of a general purpose single- or multi-chip processor, a DSP, an ASIC, an FPGA or other programmable logic device, discrete gate or transistor logic, or discrete hardware components. In some implementations, the control system 330 may include a processor 332. The control system 330 may be capable of performing some or all of the methods described herein. According to some examples, the control system 330 may be capable of performing a method described in a process 900, which is shown in FIG. 9. In some implementations, the control system 330 may be capable of controlling one or more components of the remote device 300. For example, the control system 330 may be capable of controlling the wireless communications component 350.

In some implementations, the control system 330 may be capable of controlling the remote device 300 according to instructions (e.g., software) stored on one or more non-transitory computer-readable media. Such non-transitory media may include the memory 340 of the remote device 300. The memory 340 can store processor-executable instructions and/or data received from another device. In some implementations, the memory 340 may be a volatile memory, non-volatile memory (e.g., flash memory), or a combination thereof. In some implementations, the memory 340 may include internal memory included in the control system 330, memory external to the control system 330, or a combination thereof. The memory 340 may be coupled to the control system 330. In some implementations, the memory 340 may store information or instructions related to a wakeup protocol of the remote device 300. For example, the memory 340 may store instructions for controlling the waking up, transmitting, and sleeping operations of the wireless communications component 350.

The remote device 300 can also include a wireless communications component 350 coupled to an antenna 354. The control system 330 may be coupled to the wireless communications component 350 to control the operations of the wireless communications component 350. For example, the control system 330 may control the operations of the wireless communications component 350 by controlling the scheduled wakeup time of the wireless communications component 350 for transmitting discovery beacons 50, the duration for transmitting discovery beacons 50, the number and frequency of discovery beacons 50, the information transmitted with the discovery beacons 50, and the channel of the discovery beacons 50, among other things. In some implementations, the wireless communications component 350 may include one or more of a receiver, a transmitter, and a two-way transceiver. While the wireless communications component 350 of the remote device 300 is shown as part of the computing device 325 in FIG. 3, it is understood that the wireless communications component 350 can be part of the carrier board 375 in addition to or in the alternative to the RF unit 378.

The wireless communications component 350 may operate in one or more frequency bands depending on the supported type of communications. In some implementations, the wireless communications component 350 may be configured to communicate with the electronic device 200 in the MICS band, MEDS band, or any other suitable frequency band. The wireless communications component 350 may be configured to transmit one or more discovery beacons 50 to establish communication with the electronic device 200, thereby pairing the remote device 300 and the electronic device 200. The wireless communications component 350 may be configured to receive data from the electronic device 200.

In some implementations, the wireless communications component 350 may be configured to communicate over one or more of a wide area network (WAN), personal area network (PAN), local area network (LAN), near-field communication (NFC) or any combination thereof. For example, the wireless communications component 350 can support communication over a personal area network (e.g., Bluetooth). The wireless communications component 350 can support communication over a wireless local area network (e.g., Wi-Fi). In some implementations, the wireless communications component 350 can wirelessly communicate data received from the electronic device 200 to a database system, such as a cloud-based database system. In some implementations, the wireless communications component 350 can wirelessly communicate data received from the electronic device 200 to a cellular device, such as a mobile phone, a tablet, PDA, laptop computer, desktop computer, or other device with cellular communication capability. In some implementations, the electronic device 200 can be a mobile phone, tablet, PDA, smartwatch, smart clothing, etc. In some implementations, the wireless communications component 350 in the computing device 325 can be differentiated from the RF unit 378 in the carrier board 375, where the wireless communications component 350 is configured to communicate with a database system or a cellular device over a particular communication protocol, and the RF unit 378 is configured to communicate with an electronic device 200 over a particular communication protocol. These particular communication protocols may or may not be different. Thus, with a computing device 325 and a carrier board 375 in the remote device 300, the wireless connectivity and the RF components of the remote device 300 can be functionally separated.

In some implementations, one or more of the clock 320, the control system 330, the memory 340, the wireless communications component 350, and any other electronic components of the remote device 300 may be powered by the power supply 360. The power supply 360 may be a battery, a solar cell, electrical socket, and other suitable power sources for harvesting power. The power supply 360 may also provide power to components of the carrier board 375.

In some implementations, the remote device 300 includes a memory 372, a controller 374, a charger 376, and an RF unit 378. The memory 372, which can include volatile memory, non-volatile memory (e.g., flash memory), or a combination thereof, can provide instructions to the controller 374. The controller 374, which can be used interchangeably with a “control system,” a “processor,” a “processing unit,” a microcontroller,” or a “control unit,” can be coupled to the memory 372 and control the operations of the charger 376 and the RF unit 378. The controller 374 may be in communication with components of the carrier board 375 and control operations of one or more components of the carrier board 375. The controller 374 may include at least one of a general purpose single- or multi-chip processor, a DSP, an ASIC, an FPGA or other programmable logic device, discrete gate or transistor logic, or discrete hardware components. The charger 376 can be configured to radiate a wireless signal from the remote device 300 to wirelessly charge a battery of another device, such as the electronic device 200. In some implementations, the charger 376 can radiate a wireless signal in the near-field range or mid-field range. In some implementations, when the electronic device 200 receives the wireless signal from the charger 376, the electronic device 200 can be automatically configured to perform data transfer with the remote device 300. The RF unit 378 can include one or more of a receiver, transmitter, and two-way transceiver to wirelessly communicate with another device, such as the electronic device 200. In some implementations, the RF unit 378 in the carrier board 375 may be configured to transmit discovery beacons 50. The controller 374 may control the operations of the RF unit 378, such as by controlling the scheduled wakeup time of the remote device 300 for transmitting discovery beacons 50, the duration for transmitting discovery beacons 50, the number and frequency of discovery beacons 50, the information transmitted with the discovery beacons 50, and the channel of the discovery beacons 50, among other things. In some implementations, the RF unit 378 may be configured to communicate with the electronic device 200 in MICS band, MEDS band, or any other frequency band. The RF unit 378 may be configured to transmit one or more discovery beacons 50 to establish communication (e.g., pair) with the electronic device 200. The wireless communications component 350 may be configured to receive data from the electronic device 200. Accordingly, in some implementations, the RF unit 378 is configured to communicate with the electronic device 200 while the wireless communications component 350 is configured to communicate with a database system or cellular device, such as a mobile phone, tablet, PDA, laptop computer, desktop computer, or other device with cellular communication capability. In some implementations, one or more of the memory 372, the controller 374, the charger 376, and the RF unit 378 may be powered by the power supply 360.

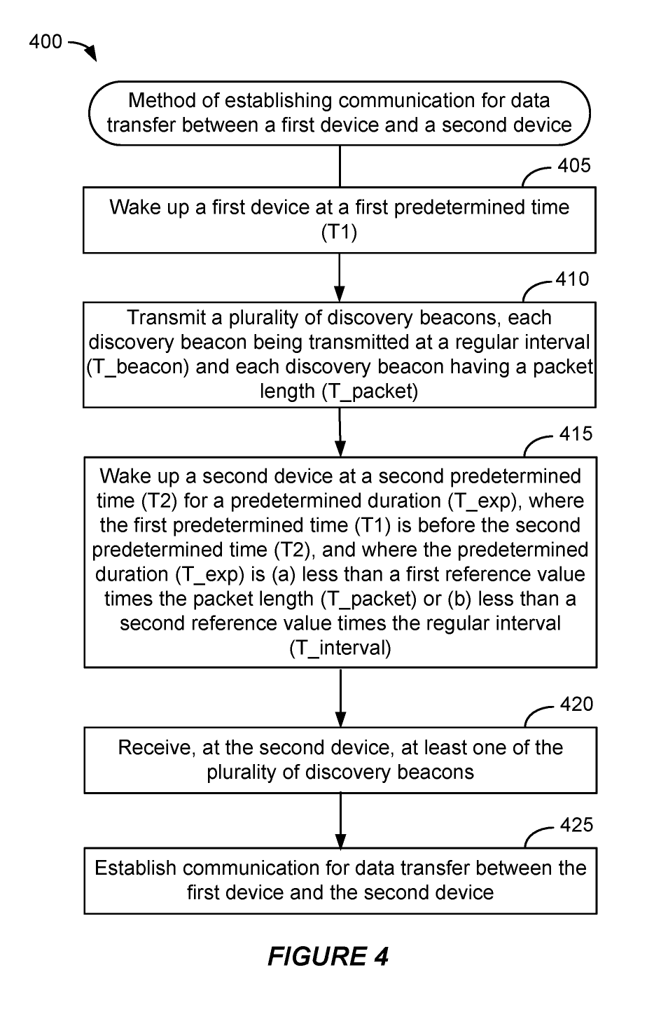

FIG. 4 shows a flow diagram illustrating an example process of establishing communication for data transfer between a first device and a second device according to some implementations. The process 400 may be performed in a different order or with different, fewer, or additional operations. In some implementations, the blocks of the process 400 may be performed by the system 100 shown in FIG. 1, the device 200 shown in FIG. 2, and/or by a device 300 shown in FIG. 3. In some implementations, the blocks of the process 400 may be implemented, at least in part, according to software stored on one or more non-transitory computer readable media.

As used herein, a “first device” can generally refer to a device capable of transmitting discovery beacons. The first device can be an electronic device including one or more components of the device 300. In some implementations, the first device can be a remote device 300 outside of a patient's body, though the first device is not intended to be limited to the remote device 300.

As used herein, a “second device” can generally refer to a device capable of receiving discovery beacons. The second device can be an electronic device including one or more components of the device 200. The second device can be battery-powered. In some implementations, the second device can be an implantable medical device or an electronic device 200 inside of a patient's body, though the second device is not intended to be limited to the electronic device 200.

The process 400 relates to device discovery between the first device and the second device. Typically, prior to initiating data transfer between two devices, the first device can be set to perform discovery while the second device can be set to be discoverable. The process 400 provides an efficient protocol by having the second device wake up from a sleep state to listen for discovery beacons at predetermined times and for a very short predetermined duration, and the first device is coordinated to transmit discovery beacons at a scheduled time right before the predetermined times. When the second device wakes up from a sleep state, at least a wireless communications component of the second device is caused to be in an active state or powered on state to listen for discovery beacons. The second device saves power by not transmitting data during discovery and by being awake for as short a time as is necessary to discover and pair with the first device.

At block 405 of the process 400, the first device wakes up at a first predetermined time (T1). Prior to waking up, the first device is not transmitting any discovery beacons. As used herein, the term “discovery beacons” can be used interchangeably with “discovery signals,” “discovery beacon signals,” or “wakeup signals.” Such signals or beacons may include a message to activate or wake up a wireless communications component of a second device so that further communications can be commenced with the second device. In some implementations, the first device is in a sleep state, such as a low power or power off inactive mode, where at least one or more components of the first device are inactive. When the first device is awake, a wireless communications component (e.g., transmitter or transceiver) is set to an active state or otherwise turned on. The first device is awakened at a “known” time T1, where the time is predetermined, pre-negotiated, or standardized. T1 may be set according to a clock value of a clock of the first device. T1 may be scheduled to occur shortly before wakeup in a second device. In some implementations, the first device can be awakened at T1 after hours of inactivity, such as more than 1 hour, more than 5 hours, more than 8 hours, more than 12 hours, or more than 24 hours of inactivity. Inactivity can refer to times where the first device is not transmitting discovery beacons or where the first device is not receiving data from another device.

At block 410 of the process 400, a plurality of discovery beacons are transmitted, each discovery beacon being transmitted at a regular interval (T_beacon) and each discovery beacon having a packet length (T_packet). The plurality of discovery beacons may be transmitted upon waking up at T1. A discovery beacon can include a message or messages associated with the discovery beacon. The message can include a wakeup message that indicates to a second device to activate. Once the wakeup message is received and the second device is activated, the second device may be capable of receiving other communications from the first device. The message can further include a request message that indicates to the second device what data the first device is requesting to retrieve. Such data can be, for example, diagnostic or operational data. In some implementations, the message can further include a clock synchronization message that indicates a timestamp associated with the transmitted discovery beacon to correct the clock value of the clock of the second device. In some implementations, the message can further include a programming message that indicates changes to the operations of the second device. For example, the message can instruct the second device to change therapy or change parameters associated with therapy. Other messages can include a physical layer (PHY) message, a management message, or another type of message. In some implementations, the message or messages associated with the discovery beacon may be limited to the wakeup message or limited to the wakeup message and the request message. That way, the amount of information transmitted in each of the discovery beacons can be minimal. More information can consume more battery power, such as periodic re-synchronization of the clock of the second device consuming more battery power of the second device. Furthermore, if the message associated with the discovery beacon is limited, the amount of power spent by the second device searching for other communications transmitted from the first device can be minimal, which can also reduce power consumption.

The number and frequency of transmissions of discovery beacons can vary. Specifically, the plurality of discovery beacons can be transmitted in different manners. One approach is to space apart each transmission of a discovery beacon, each transmission occurring at a periodic frequency. Another approach is to “shotgun” the transmissions of the discovery beacons as a series of packets in rapid succession. Each transmission is minimally spaced apart and several packets can be transmitted within a very short time frame. In some implementations of this approach, at least 1,000 discovery beacons are transmitted in 10 seconds or less. While such an approach may consume more power and result in “wasteful” transmissions, the use of power and the waste of transmissions may not be a significant concern with the first device. Other approaches may be utilized in the transmission of discovery beacons, such as an approach that is a hybrid of the aforementioned approaches. For example, some of the plurality of discovery beacons can be initially transmitted in a shotgun approach followed by a more spaced apart series of transmissions of discovery beacons.

Each transmission of discovery beacons can occur at intervals T_beacon and each discovery beacon can have a length T_packet. In implementations where each transmission of the discovery beacon is more spaced apart from each other, T_beacon can be less than about 1 second, less than about 500 milliseconds, less than about 300 milliseconds, less than about 200 milliseconds, or less than about 100 milliseconds. In implementations where each transmission of the discovery beacon is minimally spaced apart in a shotgun approach, T_beacon can be less than about 5 milliseconds, less than about 3 milliseconds, less than about 1 millisecond, less than about 0.5 milliseconds, or less than about 0.1 millisecond. T_packet can be on the order of milliseconds, such as on the order of a few milliseconds or less. In some implementations, T_packet can be less than about 10 milliseconds, less than about 5 milliseconds, less than about 3 milliseconds, or less than about 1 millisecond. Accordingly, the length between each transmission of the plurality of discovery beacons can be short, such as on the order of a few hundred milliseconds or even less, and the length of each discovery beacon can be very short, such as on the order of a few milliseconds.

In some implementations, the transmission of the discovery beacons can occur on a particular channel that is known by a second device (e.g., preassigned, preset, or predetermined). The particular channel may be preassigned so that the first device is configured to transmit discovery beacons on that channel and the second device is configured to receive discovery beacons on that channel. Consequently, the second device does not have to scan multiple channels to search for the particular channel that the discovery beacons are communicating on.

In some implementations, the transmission of the discovery beacons can occur on a particular channel that is not known by the second device. In some implementations, designating a single channel for operation may not be practical since channel availability at different geographies may be subject to occupancies by other devices. For example, weather balloons, amateur radios, and walkie talkie radios may occupy the desired channel for communication between the first device and the second device. This kind of interference can occur depending on the location or other factors in which the first device and the second device are communicating. Accordingly, the discovery beacons may be transmitted on a certain channel selected from a plurality of channels in a frequency band. If the frequency band is the MICS band, for example, then the discovery beacons can be transmitted on one of the channels in the MICS band. The second device may search for the channel in the frequency band according to a certain sequence, which is described in more detail below.

At block 415 of the process 400, a second device is awakened at a second predetermined time (T2) for a predetermined duration (T_exp), where the first predetermined time (T1) is before the second predetermined time (T2), and where the predetermined duration (T_exp) is (a) less than a first reference value times the packet length (T_packet), or (b) less than a second reference value times the regular interval (T_beacon). The length of the predetermined duration (T_exp) can depend on the packet length (T_packet) or depend on the regular interval (T_beacon). Thus, the length of the predetermined duration (T_exp) can be proportionally related to the packet length (T_packet) or the regular interval (T_beacon). The first reference value and the second reference value can serve as threshold values by which the predetermined duration (T_exp) cannot exceed with respect to the packet length (T_packet) or the regular interval (T_beacon). In some implementations, the first reference value can be a value that is less than 10, less than 8, or less than 5, and the second reference value can be a value that is less than 10, less than 8, or less than 5.

Before receiving any communication from the first device, the second device is scheduled to wake up at a known time T2, where the time T2 is predetermined, pre-negotiated, or standardized. Prior to waking up, the second device is in a low power or power off inactive mode. This means that at least the wireless communications component (e.g., receiver or transceiver) of the second device is inactive or in a sleep state. The wireless communications component of the second device can be powered off in the sleep state to conserve power. Other components of the second device may or may not be powered off during the sleep state. When the second device is awakened at T2, the wireless communications component is caused to be in an active state, meaning that the wireless communications component is turned on to listen for discovery beacons for a limited period of time. In some implementations, the wireless communications component enters an active state after hours in the sleep state, such as more than 1 hour, more than 5 hours, more than 8 hours, more than 12 hours, or more than 24 hours of being in the sleep state.

T2 may be scheduled according to a clock value of a clock of the second device. The clock of the second device may be subject to drift, where a drift of the clock can reflect the degree of accuracy of the clock with respect to a reference time. Due to a variety of factors, the clock of the second device and the clock of the first device may run at different rates, causing the clocks to drift with respect to one another over time. Because the second device generally operates in a low-power state, the clock of the second device may be more subject to drift. To account for the phenomenon of drift associated with the second device, the first device wakes up at T1 before the second device wakes up at T2.

How much earlier the first device wakes up before the second device wakes up can be determined by a clock drift associated with the clock of the second device. Thus, how much later the wireless communications component of the second device enters the active state at T2 than when the first device is activated at T1 can be based at least in part on the clock drift. Clock drift can be measured in PPM. In some implementations, the amount of time that T1 is before T2 is T_drift, where T_drift can be at least the clock drift multiplied by the time span since the second device last woke up or since the second device last re-synchronized its clock. The time span since the second device last woke up can be a regular period (T_schedule), where T_schedule represents the regular period of time that passes until the wireless communications component of the second device enters an active state from a sleep state. Or, T_schedule can be the regular period of time that passes until the second device re-synchronizes its clock with the clock of the first device. In some implementations, T_drift can be at least twice the clock drift (D) multiplied by the time span since the second device last woke up or last re-synchronized with the first device: T_drift=2*D*T_schedule. By way of example, if the clock drift associated with the second device is 20 PPM, and the amount of time that passed since the second device last woke up is 4 hours (14,400 seconds), then T_drift can be calculated to be 0.576 seconds. Therefore, the first device can account for the drift associated with the second device by waking up at a scheduled time that is earlier by T_drift.

The second device wakes up, or more specifically the wireless communications component of the second device enters an active state to listen for discovery beacons, at T2 for a predetermined duration (T_exp). How long T_exp lasts can be known (e.g., predetermined, pre-negotiated, or standardized). T_exp can last for a very short duration to save power. In some implementations, such as where the transmissions of the discovery beacons are regularly spaced apart by T_beacon intervals, T_exp can be less than 10 times T_beacon. In some implementations, T_exp can be between about 2-5 times T_beacon, or 2-3 times T_beacon. By way of example, if the regular interval between discovery beacon transmissions were 200 milliseconds, then the duration that the second device is awake listening for discovery beacons can be 400 milliseconds or 600 milliseconds. In some implementations, such as where the discovery beacons are transmitted as a series of packets in minimally spaced apart intervals (e.g., shotgun approach), T_exp can be less than 10 times T_packet. In some implementations, T_exp can be between about 2-5 times T_packet, or 3-4 times T_packet. By way of example, if the packet length of a discovery beacon were 3 milliseconds, then the duration that the second device is awake listening for the discovery beacons can be 9 milliseconds or 12 milliseconds. Accordingly, the time frame of T_exp can reliably expect to cover the time frame for detecting at least one discovery beacon when the first device is transmitting nearby. If the first device is discoverable nearby, then T_exp is just long enough for the second device to detect at least one discovery beacon being transmitted and just short enough to significantly reduce power consumption. In some implementations, the power consumed by the second device can be on the order of nanowatts, such as 1 nanowatt or less per cycle.

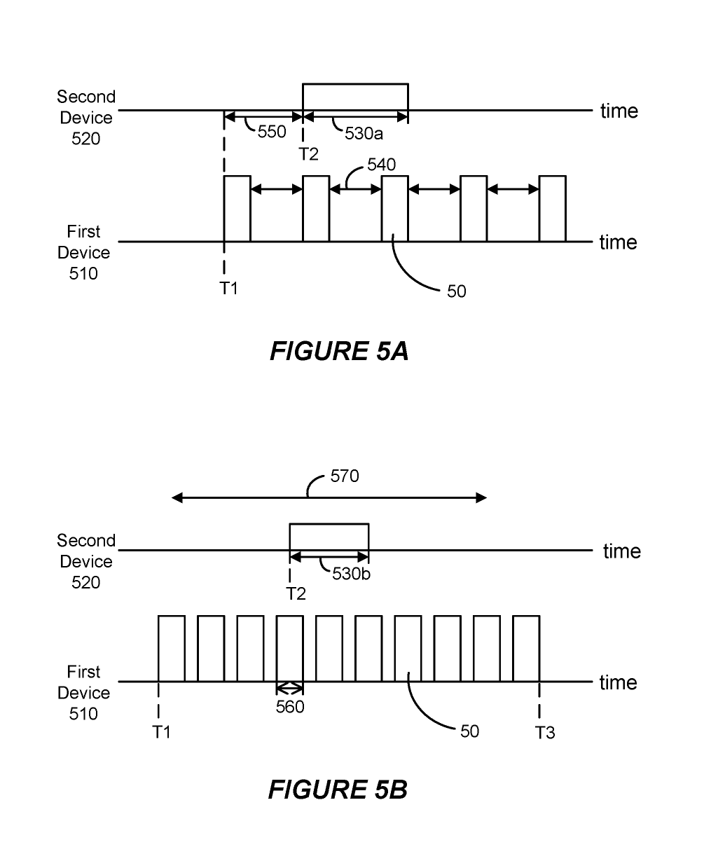

FIG. 5A shows a timing diagram illustrating an example wakeup protocol of a first device and a second device according to some implementations. In the timing diagram, a first device 510 wakes up at T1 and begins transmitting a series of discovery beacons 50. Each of the transmissions can be spaced apart by a regular interval 540. A second device 520 wakes up at T2 for a duration 530a (awake time), where T2 begins following a drift time 550 after T1. The drift time 550 accounts for a clock drift associated with the second device 520. In some implementations, the drift time 550 can be at least twice the clock drift associated with the second device 520 multiplied by the time span since the last wakeup time of the second device 520 or the last time the second device 520 re-synchronized its clock with the first device 510. The second device 520 wakes up for the duration 530a, which can be about 2-5 times the regular interval 540. In FIG. 5A, the duration 530a can be about 2 times the regular interval 540. The duration 530a can ensure that at least one of the discovery beacons 50 can be received while the second device 520 is awake.

FIG. 5B shows a timing diagram illustrating an example wakeup protocol of a first device and a second device according to some other implementations. In the timing diagram, a first device 510 wakes up at T1 and begins transmitting a series of discovery beacons 50. The series of discovery beacons 50 are negligibly spaced apart, but can be sent as a stream of packets in rapid succession. Each discovery beacon 50 can have a packet length 560. In the timing diagram, the first device 510 ends transmission of the discovery beacons 50 at T3. The second device 520 wakes up at T2 for a duration 530b (awake time). In some implementations, T1 can account for the clock drift associated with the second device 520. The second device 520 wakes up for the duration 530b, which can be 2-5 times the packet length 560. In FIG. 5B, the duration 530b can be about 3 times the packet length 560. The duration 530b can ensure that at least one of the discovery beacons 50 can be received while the second device 520 is awake. How long the first device 510 continues to transmit discovery beacons 50 in rapid succession can be based at least in part on a timing uncertainty 570 of the second device 520. Since the last time the second device 520 woke up or since the last time the second device 520 re-synchronized its clock (T_schedule), the timing uncertainty 570 of the second device 520 can be calculated using the clock drift associated with the second device 520. For example, the timing uncertainty 570 can be 2*D*T_schedule, where the span between T1 to T3 covers the timing uncertainty 570. Thus, the span of T1 to T3 is long enough to ensure that transmission of the discovery beacons 50 are sent within the timing uncertainty 570 of the second device 520, and the second device 520 is awake long enough to receive at least one of the discovery beacons 50. In FIG. 5B, if T_packet is a few milliseconds and the timing uncertainty is several seconds after one day has passed, then the duration 530b can be a few or several milliseconds so that little power is consumed by the second device 520.

Returning to FIG. 4, when the second device wakes up at T2 at block 415, the second device may wake up on a preassigned channel according to some implementations. The preassigned channel may correspond to the preassigned channel that the first device is configured to transmit discovery beacons on. However, in some other implementations, the second device may not know the channel that the first device is transmitting discovery beacons on. The second device may select a channel or channels in a frequency band, where the selection of the channel or channels can follow a certain pattern of searching in the frequency band. In some implementations, the process 400 includes the second device searching across a plurality of channels in a frequency band according to a process 600 shown in FIG. 6.

At block 420 of the process 400, at least one of the plurality of discovery beacons is received at the second device. A wireless communications component (e.g., receiver or transceiver) in the active state can receive one of the transmitted discovery beacons during T_exp. As discussed above, a wakeup message in the discovery beacon can cause the second device to be activated, which can result in one or more components of the second device being turned on. In some implementations, additional messages associated with the discovery beacon may be received by the second device, such as requests for data to be transferred from the second device to the first device or instructions to synchronize the clock of the second device with the clock of the first device. Receipt of the discovery beacon can cause the second device to remain awake for an extended time (T_extend) for session initiation. During this extended time, the wireless communications component of the second device might not be listening for discovery beacons, but can at least be listening for a session initiation communication. The session initiation communication can include a message regarding what data is to be transferred from the second device to the first device. The first device may transmit a session initiation communication that the second device validates before T_extend expires, and the second device may respond by providing the data requested by the first device. Having wireless communications component of the second device listening for discovery beacons rather than constantly generating and transmitting signals for the first device to detect can reduce power consumption in the second device.

In some implementations, the first device may transmit a discovery beacon that is received by the second device, but does not transmit a session initiation communication for requesting transferring of data. After T_extend expires, then the second device returns to sleep. In some implementations, the first device may not be in sufficient proximity or may not be operable so that any of its transmitted discovery beacons are received by the second device. If the second device fails to receive a discovery beacon during T_exp, then the second device returns to sleep. In some implementations, if the second device receives a discovery beacon before expiration of T_exp, and a session is initiated between the first device and the second device, then the second device may return to sleep after completion of the session, such as after completion of data transfer.

At block 425 of the process 400, communication is established for data transfer between the first device and the second device. After the discovery beacon is received by the second device, the first device and the second device detect one another's presence. In some implementations, the first device and the second device can be paired to establish secured communications. In some implementations, the second device may authenticate that the discovery beacon was sent from a valid device. If so, the second device may transmit a “handshake” acknowledgement signal to the first device so as to establish or commence further communications. The first device may send a session initiation communication to the second device requesting data from the second device, and the second device may respond with the requested data. In some implementations, the second device may send diagnostic/operational data to the first device. The second device may return to sleep after completion of the session.

After returning the second device to sleep, the process 400 can further include waking up the second device at regular periods (T_schedule). The second device may return to sleep after completion of a session for data transfer, after failing to receive a discovery beacon, or after failing to receive a session initiation communication following receipt of a discovery beacon. The second device may sleep until the next scheduled wakeup, which can occur after T_schedule. T_schedule can be relatively long so as to minimize power consumption by the second device. In some implementations, T_schedule is longer than 1 hour, longer than 4 hours, longer than 8 hours, longer than 12 hours, or longer than 24 hours. Thus, the duty cycle for the time in which the second device is awake versus the time in which the second device is asleep can be relatively small. The second device is awake listening for discovery beacons at a low frequency and for very short durations.

As discussed earlier herein, designating a single channel for operation may not be practical since channel availability at different geographies may be subject to occupancies by other devices. In such instances, transmission and receipt of discovery beacons may not occur on a preassigned or predetermined channel. Communications by the first device, including transmission of discovery beacons or session initiation communications, can occur on a certain channel selected from a plurality of channels in a frequency band. The second device may search for the channel in the frequency band according to a certain sequence or pattern.

FIG. 6 shows a flow diagram illustrating an example process of searching across a plurality of channels in a frequency band according to some implementations. The process 600 may be performed in a different order or with different, fewer, or additional operations. In some implementations, the blocks of the process 600 may be performed by the system 100 shown in FIG. 1, and/or by the device 200 shown in FIG. 2. In some implementations, the blocks of the process 600 may be implemented, at least in part, according to software stored on one or more non-transitory computer readable media.

At block 605 of the process 600, a channel of a previous data transfer between a first device and a second device is selected. If the first device and the second device previously communicated on a particular channel, there is a higher likelihood that the first device will remain on the same channel for subsequent communications. If the second device discovers the first device on the selected channel at block 610, then communication for data transfer between the first device and the second device is established at block 615. Data transfer can occur on the selected channel. The second device need not continue searching across the plurality of channels in the frequency band.

If the second device fails to discover the first device on the selected channel at block 610, then the second device searches one or more channels furthest from the channel of the previous data transfer at block 620. In some implementations, these one or more channels may be referred to as discovery channels. The process 600 can proceed to block 620 if no discovery beacon is received at the selected channel after a designated time. In some implementations, the designated time can equal a maximum number of attempts (N_max_tries) multiplied by T_beacon. The reason for continued searching might be that if a portion of the frequency band is occupied, discovery of the first device can still occur on another portion of the frequency band. Instead of searching at a channel adjacent to the selected channel that is potentially occupied, the second device can search one or more channels furthest from the previously selected channel. This can broaden the search of channels and reduce the likelihood of searching a channel where there is interference.

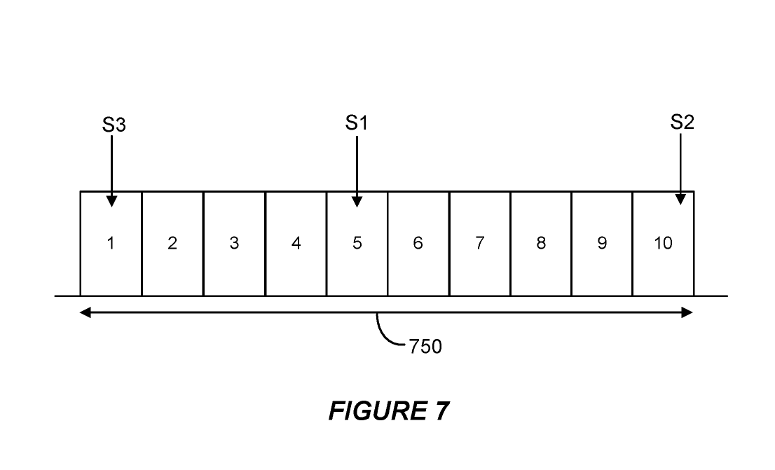

At block 625 of the process 600, if the second device discovers the first device on one of the searched channels, then communication for data transfer between the first device and the second device can be established. Data transfer can occur on the searched channel. If the second device fails to discover the first device on one of the searched channels at block 625, then at block 635 the second device searches across a remainder of channels in an order that progressively gets closer to the channel of the previous data transfer. The process 600 can proceed to block 635 if no discovery beacon is received at the searched channel or channels after a designated time, where the designated time can be N_max_tries*T_beacon. The second device continues searching the remainder of channels in the frequency band until a discovery beacon is detected on a particular channel. In some implementations, if the second device fails to discover the first device, the second device may undergo multiple rounds of searching across the plurality of channels by repeating the process 600. In some implementations, the number of rounds (N_rounds) can be less than 10 rounds, less than 5 rounds, or less than 3 rounds. Otherwise, the second device returns to a sleep mode until a next scheduled wakeup. The searching pattern in the process 600 may minimize the amount of searching by the second device while it is awake. An example of a plurality of channels to be searched in a frequency band is shown in FIG. 7.

FIG. 7 shows a block diagram representation of discovery channels in a frequency band according to some implementations. The frequency band 750 can be divided into 10 channels. In some implementations, where the frequency band 750 is the MICS band that is between 402 MHz and 405 MHz, each channel can be 300 KHz in length. In some implementations, discovery channels can be channels to be searched in the frequency band. In some implementations, discovery channels S1, S2, and S3 can be selected as channels 1, 5, and 10, which provides for frequency diversity.

By way of an example in FIG. 7, if the first device and the second device previously communicated on channel 2, and channel 2 is no longer valid, then the second device can transition to discovery and start searching on channel 10 because it is furthest from channel 2. From there, the second device can search progressively closer to channel 2. By way of another example in FIG. 7, if the first device and the second device previously communicated on channel 5, and channel 5 is no longer valid, then the second device can transition to discovery and search on channel 10 because it is furthest from channel 5, and search on channel 1 because it is next furthest from channel 5.

An efficient wakeup protocol, including an efficient searching protocol of channels in a frequency band, may be configured in a first device and a second device. The first device can include a wireless communications component (e.g., transmitter or transceiver) configured to transmit a plurality of discovery beacons and a control system coupled to the wireless communications component. The control system can be configured to perform the operations shown in the process 900 of FIG. 9. In some implementations, the first device can be a base station or remote device. The second device can include a wireless communications component (e.g., receiver or transceiver) configured to receive a discovery beacon and a control system coupled to the wireless communications component. The control system can be configured to perform the operations shown in the process 800 of FIG. 8. In some implementations, the second device can be an implantable medical device or implant device.

FIG. 8 shows a flow diagram illustrating an example process for waking up an electronic device to establish communication for data transfer with a remote device according to some implementations. The process 800 may be performed in a different order or with different, fewer, or additional operations. In some implementations, the blocks of the process 800 may be performed by the device 200 shown in FIG. 2. In some implementations, the blocks of the process 800 may be implemented, at least in part, according to software stored on one or more non-transitory computer readable media.

At block 805 of the process 800, the electronic device is awakened at a predetermined wakeup time (T2) for a predetermined duration (T_exp). Prior to waking up the electronic device, the wireless communications component can be in a sleep state so that it is inactive. Other components of the electronic device may be inactive to save power. When the wireless communications component is caused to be in an active state, the wireless communications component is active in a listening mode, discovery mode, or sniff mode so that the wireless communications component is capable of receiving a discovery beacon. In some implementations, the control system is configured to cause the wireless communications component to be in the active state at the predetermined wakeup time on a preassigned channel. In some implementations, the control system is configured to select a channel on a frequency band for establishing communication for data transfer between the electronic device and a remote device. The control system may be further configured to perform a search across a plurality of channels in the frequency band according to a predetermined sequence. An example of a predetermined sequence can be shown in aspects of the process 600 of FIG. 6.

At block 810 of the process 800, a discovery beacon may be received. At least one of a plurality of discovery beacons transmitted by a remote device may be received at the wireless communications component. The discovery beacon may be received during T_exp, where T_exp is (a) less than a first reference value times a packet length (T_packet) of a discovery beacon or (b) less than a second reference value times a regular interval (T_beacon) between each of the plurality of discovery beacons. In some implementations, each of the first reference value and the second reference value can be a value that is less than 10, less than 8, or less than 5. In some implementations, the remote device can wake up at a predetermined drift time (T1) before T2. T1 can be earlier before T2 based on a clock drift associated with the electronic device. In some implementations, the electronic device can further include a clock having a clock drift. The wireless communications component of the electronic device can be caused to be in the active state at T2 after T1 by a duration that is based at least in part on the clock drift. The wireless communications component of the electronic component can be caused to be in the active state at T2 after T1 by at least twice the clock drift multiplied by the time span since the electronic device last woke up. The remote device can be coordinated with the electronic device to be activated shortly before the electronic device to account for clock drift.

The electronic device may be awake for a very short duration to listen for discovery beacons. In some implementations, T_exp can be 5 milliseconds or less. In some implementations, T_exp can be just long enough to receive at least one discovery beacon from the remote device and just short enough to significantly reduce power consumption. When the remote device is activated at T1, the remote device may transmit a plurality of discovery beacons at regular intervals T_beacon. The regular intervals may be less than about 1 second, less than about 500 milliseconds, less than about 300 milliseconds, less than about 200 milliseconds, or less than about 100 milliseconds. In some implementations, T_exp can be between 2-5 times T_beacon, or between 2-3 times T_beacon. Alternatively, when the remote device is activated at T1, the remote device may transmit a plurality of discovery beacons in rapid succession. For example, the plurality of discovery beacons can include at least 1,000 discovery beacons transmitted in 10 seconds or less. Each discovery beacon can have a packet length T_packet, and the regular intervals between each discovery beacon may be negligible. In some implementations, T_exp can be between 2-5 times T_packet, or between 3-4 times T_packet.

If no discovery beacon is received by the electronic device at block 810, then the electronic device returns to sleep for a regular period (T_schedule) at block 815. T_schedule can represent the time span that the wireless communications component is inactive before the next scheduled wakeup. The control system of the electronic device can be configured to cause the wireless communications component to be in the active state at T_schedule upon returning the wireless communications component to a sleep state. To further reduce power consumption, T_schedule can be a long time span. In some implementations, T_schedule is longer than 1 hour, longer than 4 hours, longer than 8 hours, longer than 12 hours, or longer than 24 hours.

In some implementations, if no discovery beacon is received by the electronic device at a selected channel in a frequency band at block 810, where the selected channel is a channel of a previous data transfer between the remote device and the electronic device, then the control system of the electronic device can be configured to perform a search across a plurality of channels in the frequency band according to a predetermined sequence. The predetermined sequence can include a search of a channel of a previous data transfer between the remote device and the electronic device, followed by a search of one or more channels furthest from the channel of the previous data transfer, and a search of a remainder of channels in an order that progressively gets closer to the channel of the previous data transfer.

If a discovery beacon is received at block 810, then communication is established for data transfer with the remote device at block 820. In some implementations, the electronic device may authenticate and acknowledge the remote device so as to establish or commence further communications. The electronic device may stay awake for an extended time (T_extend) to listen for a session initiation request. The remote device may send a session initiation request to request data from the electronic device. The electronic device may respond by sending the requested data to the remote device.

At block 825 of the process 800, the electronic device is returned to sleep for a regular period (T_schedule). After data transfer is completed between the remote device and the electronic device, the electronic device can return to sleep until the next scheduled wakeup time. Thus, the wireless communications component of the electronic device can be set to a sleep state until the next scheduled wakeup time to cause the wireless communications component to be in the active state again.

FIG. 9 shows a flow diagram illustrating an example process for waking up a remote device to establish communication for data transfer with an electronic device according to some implementations. The process 900 may be performed in a different order or with different, fewer, or additional operations. In some implementations, the blocks of the process 900 may be performed by the device 300 shown in FIG. 3. In some implementations, the blocks of the process 900 may be implemented, at least in part, according to software stored on one or more non-transitory computer readable media.

At block 905 of the process 900, the remote device is awakened at a predetermined drift time (T1). Prior to waking up, the wireless communications component of the remote device can be in a low power or power off inactive mode so that it is not transmitting discovery beacons. Upon waking up, the wireless communications component can be caused to be in an active state to transmit discovery beacons. In some implementations, a control system coupled to the wireless communications component can cause the wireless communications component to be in the active state at T1 on a preassigned channel. In some implementations, the control system of the remote device is configured to cause the wireless communications component to be in the active state at T1 on a selected channel not known by an electronic device.

At block 910 of the process 900, the remote device transmits a plurality of discovery beacons, each discovery beacon being transmitted at a regular interval (T_beacon) and each discovery beacon having a packet length (T_packet). In one approach, the plurality of discovery beacons may be transmitted at regularly spaced apart intervals, where T_beacon may be less than about 1 second, less than about 500 milliseconds, less than about 300 milliseconds, less than about 200 milliseconds, or less than about 100 milliseconds. In another approach, the plurality of discovery beacons may be transmitted in rapid succession and in minimally spaced apart intervals. For example, the plurality of discovery beacons can include at least 1,000 discovery beacons transmitted in 10 seconds or less.

At block 915 of the process 900, an acknowledgement signal may be received by the remote device. The acknowledge signal may include a message indicating that a discovery beacon has been received by an electronic device. The electronic device may wake up at a predetermined wakeup time (T2) after T1. T2 can be after T1 based on a clock drift associated with the electronic device. In some implementations, the electronic device can further include a clock having a clock drift. The wireless communications component of the remote device can be caused to be in the active state at T1 before T2 by a duration based at least in part on the clock drift associated with the electronic device. The wireless communications component of the remote device can be caused to be in the active state at T1 before T2 by at least twice the clock drift D multiplied by the time span since the electronic device last woke up. The remote device can be coordinated with the electronic device to wake up shortly before the electronic device to account for clock drift.

The electronic device can be configured to wake up at T2 for a predetermined duration (T_exp). In some implementations, T_exp can be between 2-5 times T_beacon, or between 2-3 times T_beacon. In some other implementations, T_exp can be between 2-5 times T_packet, or between 3-4 times T_packet. In some implementations, T_exp can be 5 milliseconds or less.

If no acknowledgment signal is received by the remote device at block 915, then the remote device returns to sleep for a regular period (T_schedule) at block 920. This can represent the time span that the wireless communications component of the remote device does not transmit discovery beacons before the next scheduled wakeup.

If an acknowledgment signal is received by the remote device at block 915, then communication is established for data transfer between the remote device and the electronic device at block 925. In some implementations, upon establishing communication, the remote device may send a session initiation request to request data from the electronic device.

At block 930 of the process 900, the remote device is returned to sleep for a regular period (T_schedule). After data transfer occurs between the remote device and the electronic device, the remote device can return to a sleep mode until the next scheduled wakeup time. Thus, the wireless communications component of the remote device can be set to a sleep state until the next scheduled wakeup time to cause the wireless communications component to be in the active state again.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a DSP, an ASIC, an FPGA or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. Moreover, various ones of the described and illustrated operations can itself include and collectively refer to a number of sub-operations. For example, each of the operations described above can itself involve the execution of a process or algorithm. Furthermore, various ones of the described and illustrated operations can be combined or performed in parallel in some implementations. Similarly, the separation of various system components in the implementations described above should not be understood as requiring such separation in all implementations. As such, other implementations are within the scope of the following claims. In some cases, the actions recited in the claims can be performed in a different order and still achieve desirable results.

1. An electronic device, comprising:
a wireless communications component configured to receive a discovery beacon;
a control system coupled to the wireless communications component, the control system configured to:
cause the wireless communications component to be in an active state at a predetermined wakeup time (T2) for a predetermined duration (T_exp);
receive, at the wireless communications component, at least one of a plurality of discovery beacons transmitted by a remote device, wherein the predetermined duration (T_exp) is 5 milliseconds or less; and
in response to the electronic device receiving at least one of the discovery beacons, establish communication for data transfer with the remote device.

2. The electronic device of claim 1, wherein the wireless communications component is caused to be in an active state at a predetermined wakeup time (T2) after the remote device is activated at a predetermined drift time (T1).

3. The electronic device of claim 2, further comprising:
a clock with an associated clock drift (D), wherein the wireless communications component is caused to be in an active state at a predetermined wakeup time (T2) after the predetermined drift time (T1) by a duration based at least in part on the clock drift (D).

4. The electronic device of claim 1, wherein the control system is further configured to:
set the wireless communications component to a sleep state after data transfer is completed with the remote device; and
cause the wireless communications component to be in the active state at regular periods (T_schedule) after setting the wireless communications component to the sleep state.

5. The electronic device of claim 4, wherein each regular period (T_schedule) is greater than 1 hour.

6. The electronic device of claim 1, wherein a packet length (T_packet) of a discovery beacon is 0.2-0.5 times the predetermined duration (T_exp).

7. The electronic device of claim 1, wherein the plurality of discovery beacons includes at least 1,000 discovery beacons transmitted in 10 seconds or less.

8. The electronic device of claim 1, wherein the control system configured to cause the wireless communications component to be in the active state at the predetermined wakeup time (T2) is configured to cause the wireless communications component to be in the active state on a preassigned channel.

9. The electronic device of claim 1, wherein the control system is further configured to:
select a channel on a frequency band for establishing communication for data transfer with the remote device.

10. The electronic device of claim 9, wherein the control system is further configured to:
perform a search across a plurality of channels in the frequency band according to a predetermined sequence; and
receive, at the wireless communications component after performing the search, at least one of the plurality of discovery beacons at one of the searched plurality of channels.

11. The electronic device of claim 10, wherein the control system configured to perform the search across the plurality of channels according to the predetermined sequence is configured to:
search a channel of a previous data transfer with the remote device;
search a channel that is furthest from the channel of the previous data transfer; and
search across a remainder of channels in an order that progressively gets closer to the channel of the previous data transfer.

12. The electronic device of claim 9, wherein the frequency band is the Medical Implant Communications Service (MICS) frequency band.

13. A remote device, comprising:
a wireless communications component configured to transmit a plurality of discovery beacons; and
a control system coupled to the wireless communications component, the control system configured to:
cause the wireless communications component to be in an active state at a predetermined drift time (T1);
transmit a plurality of discovery beacons to be received by an electronic device, wherein the wireless communications component is caused to be in the active state at the predetermined drift time (T1) before the electronic device is activated at a predetermined wakeup time (T2), each discovery beacon being transmitted at a regular interval (T_beacon), the electronic device being activated for a predetermined duration (T_exp) that is 5 milliseconds or less; and
establish communication for data transfer with the electronic device.

14. The remote device of claim 13, wherein the wireless communications component is caused to be in an active state at the predetermined drift time (T1) before the predetermined wakeup time (T2) by a duration based at least in part on a clock drift (D) associated with the electronic device.

15. The remote device of claim 13, wherein the control system is further configured to:
set the wireless communications component to a sleep state after data transfer is completed with the electronic device; and
cause the wireless communications component to be in the active state for transmitting discovery beacons at regular periods (T_schedule) after setting the wireless communications component to the sleep state.

16. The remote device of claim 15, wherein each regular period (T_schedule) is greater than 1 hour.

17. The remote device of claim 13, wherein the control system is further configured to:
receive an acknowledgment signal, wherein the acknowledgment signal includes a message indicating receipt of one of the plurality of discovery beacons by the electronic device, wherein the control system is configured to establish communication for data transfer with the electronic device upon receiving the acknowledgment signal.

18. A non-transitory computer readable medium having software stored thereon, the software including processor-executable instructions for causing an electronic device to:
cause a wireless communications component of the electronic device to be in an active state at a predetermined wakeup time (T2) for a predetermined duration (T_exp);
receive at least one of a plurality of discovery beacons transmitted by a remote device, wherein the predetermined duration (T_exp) is 5 milliseconds or less; and
in response to the electronic device receiving at least one of the discovery beacons, establish communication for data transfer with the remote device.

19. The non-transitory computer readable medium of claim 18, wherein the software further includes processor-executable instructions for causing the electronic device to:
set the wireless communications component to a sleep state after data transfer is completed with the remote device; and
cause the wireless communications component to be in the active state at regular periods (T_schedule) after setting the wireless communications component to the sleep state.

20. The non-transitory computer readable medium of claim 19, wherein the electronic device includes a clock with an associated clock drift (D), wherein the wireless communications component is caused to be in an active state at a predetermined wakeup time (T2) after the remote device is activated at a predetermined drift time (T1), the wireless communications component being caused to be in the active state at the predetermined wakeup time (T2) after the predetermined drift time (T1) by a duration based at least in part on the clock drift (D).

21. The non-transitory computer readable medium of claim 19, wherein each regular period (T_schedule) is greater than 1 hour.
